(19) United States
(12) Patent Application Publication
(10) Pub. No.: US 2025/0096994 A1
(43) Pub. Date: Mar. 20, 2025

(54) ETHERNET FRAME COMMUNICATION OVER SYNCHRONOUS COMMUNICATION NETWORK

(71) Applicant: Analog Devices, Inc., Wilmington, MA (US)

(72) Inventors: Martin KESSLER, Salem, MA (US); Neelamegam SUBRAMANI, Ashland, MA (US); Lewis F. LAHR, Dover, MA (US)

(21) Appl. No.: 18/468,395

(22) Filed: Sep. 15, 2023

(51) Int. Cl. H04L 5/14; H04L 12/40

(52) U.S. Cl. CPC H04L 5/14; H04L 12/4013

(57) ABSTRACT

A communication system includes a plurality of nodes connected in a daisy-chain via respective bus links. The plurality of nodes are configured for full-duplex, synchronized communication over the bus links for transmission of Ethernet frames within a flexible payload of superframes on the bus links. A node is configured to: determine that the node has a transmit token; transmit an Ethernet frame within a tunnel on the full-duplex bus links in at least one of an upstream direction towards a main-node or a downstream direction towards an end-sub-node; receive, while transmitting the Ethernet frame, a request for the transmit token from one or more other nodes in the tunnel on at least one of the full-duplex bus links in a direction opposite the Ethernet frame; and transmit the transmit token to a next node based on an order of priority of the one or more other nodes.

### TECHNICAL FIELD

This disclosure is related to wired communication systems, and more particularly to Ethernet frame communication over synchronous, full-duplex daisy-chained communication systems.

### INTRODUCTION

Audio communication within vehicles has moved from analog signals (with one or two analog wires per signal) to digital communications (with multiple audio streams on a single wire or wire-pair). Example digital audio communication technologies may use a one-directional ring topology. Other technologies, e.g., Ethernet use a point-to-point technology that requires an Ethernet switch between each bus as well costly audio clock regeneration at each node.

A2B is a true daisy-chained network with low latency because it does not require store-and-forward between nodes. A2B uses line coding and is time division multiplexed. Although A2B is the most established low latency audio communication in the car today, improvements in bandwidth may be useful to support future applications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to a method of transmitting Ethernet frames over a plurality of nodes connected in a daisy-chain over full-duplex bus links, the method including: determining that a node has a transmit token; transmitting an Ethernet frame within a tunnel on the full-duplex bus links in at least one of an upstream direction toward a main-node or a downstream direction toward an end-sub-node; receiving, while transmitting the Ethernet frame, a request for the transmit token from one or more other nodes in the tunnel on at least one of the full-duplex bus links in a direction opposite the Ethernet frame; and transmitting the transmit token to a next node of the other nodes based on an order of priority of the one or more other nodes after transmitting the Ethernet frame.

In some aspects, the techniques described herein relate to a node for transmitting Ethernet frames over a plurality of nodes connected in a daisy-chain over full-duplex bus links, the node including a transceiver configured to: determine that the node has a transmit token; transmit an Ethernet frame within a tunnel on the full-duplex bus links at least one of an upstream direction towards a main-node or a downstream direction towards an end-sub-node; receive, while transmitting the Ethernet frame, a request for the transmit token from one or more other nodes in the tunnel on at least one of the full-duplex bus links in a direction opposite the Ethernet frame; and transmit the transmit token to a next node of the other nodes based on an order of priority of the one or more other nodes.

In some aspects, the techniques described herein relate to a communication system including: a plurality of nodes connected in a daisy-chain via respective bus links, wherein the plurality of nodes are configured for full-duplex, synchronized communication via a carrier-based modulation scheme over the bus links for transmission of superframes including a flexible payload, wherein to transmit Ethernet frames for an Ethernet tunnel among the plurality of nodes, a respective node of the Ethernet tunnel is configured to: determine, based on a programmable register, a media access control (MAC) address of the respective node within the daisy-chain; and transmit a plurality of superframes over one or both of an upstream full-duplex bus link or a downstream full-duplex bus link based on the MAC address of the node, wherein each superframe includes a portion of the Ethernet frame within a portion of the flexible payload assigned to the tunnel. To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

To provide a more complete understanding of the present disclosure and features and advantages thereof, reference may be made to the following description, taken in conjunction with the accompanying figures, wherein like reference numerals represent like parts, in which:

FIG. 1 is a diagram of a nodes in a daisy-chain, according to an aspect of the disclosure;

FIG. 2 is a diagram of communication layers with a daisy-chain as the physical layer, according to an aspect of the disclosure;

FIG. 3 is a diagram of examples of frame structures, according to an aspect of the disclosure;

FIG. 4 is a diagram of an example communication system for Ethernet communication over a daisy-chain; according to an aspect of the disclosure;

FIG. 5 is a diagram of token management in a daisy-chain for Ethernet communication, according to an aspect of the disclosure;

FIGS. 6A and 6B show a series of exchanges with token management in a daisy-chain for Ethernet communication, according to an aspect of the disclosure;

FIG. 7 is a diagram of a full-duplex tunnel on a daisy-chain for Ethernet communication, according to an aspect of the disclosure;

FIG. 8 is a diagram of a programmable register for Ethernet communication on a daisy-chain, according to an aspect of the disclosure; and

FIG. 9 is a flowchart of an example method performed by a node in a daisy-chain, according to an aspect of the disclosure.

### DETAILED DESCRIPTION

Ethernet uses asynchronous communication but Audio-synchronous networks are better suited for audio communication since they are lower latency, more bandwidth efficient. do not require Ethernet switches between links, do not require (time sensitive network) TSN features and fractional phase locked loops (PLL) for audio clock re-generation at each node. A line topology with daisy-chained nodes and bi-directional communication optimizes the wiring effort. In some systems, both audio synchronous communication and Ethernet communication e.g. for status/control messaging or software updates is required between nodes. But adding additional cable for Ethernet is an undesirable option, for example, due to cost, complexity, and weight. Here, a new mechanism allows an audio synchronous, daisy-chained network to also transport Ethernet frames between any of the nodes with the daisy-chained bus as a shared physical medium.

In an aspect, the present disclosure describes a daisy-chain communication system that uses completely new framing optimized for bi-directional, synchronous communication. The daisy-chain communication system supports a flexible payload (not fixed slots as in A2B) that can carry synchronous and asynchronous communication. In an aspect, the flexible payload can carry Ethernet frames in a tunnel that includes all of the nodes or a subset of the nodes. A unique token exchange mechanism provides transmit opportunities to each node for half-duplex unicast, multicast and broadcast. But point-to-point full-duplex communication is also possible. The Ethernet tunnel takes advantage of the full-duplex nature of the bus. Since the Ethernet data is only sent upstream to the upstream nodes and downstream to the downstream nodes, token requests happen downstream from the upstream node and upstream from the downstream node, making use of the channel opposite the Ethernet data.

In some implementations, the Ethernet framing includes a unique priority scheme in which the current token owner increments a token counter referred to as a global ethernet priority access number (GEPRAN) for every token request and broadcasts the GEPRAN counter to the other nodes. All other nodes keep track of GEPRAN and any new local Ethernet message is assigned an ethernet priority access number (EPRAN) equal to the GEPRAN. Nodes that don't hold the token request the token with the EPRAN number associated to the oldest message that they had pending. The token holder can then provide the token to the node with the lowest EPRAN number token request (for a first-come/first-served scheme). When more than one node, has a simultaneous token request with the same EPRAN number, then the node closer to the main node gets the token (a tie-breaker rule). Other priority schemes are also possible. For example, a hub node may take priority over other nodes or retain the token after completing an Ethernet frame. As another example, under some conditions, a node may indicate a special priority that beats the EPRAN number.

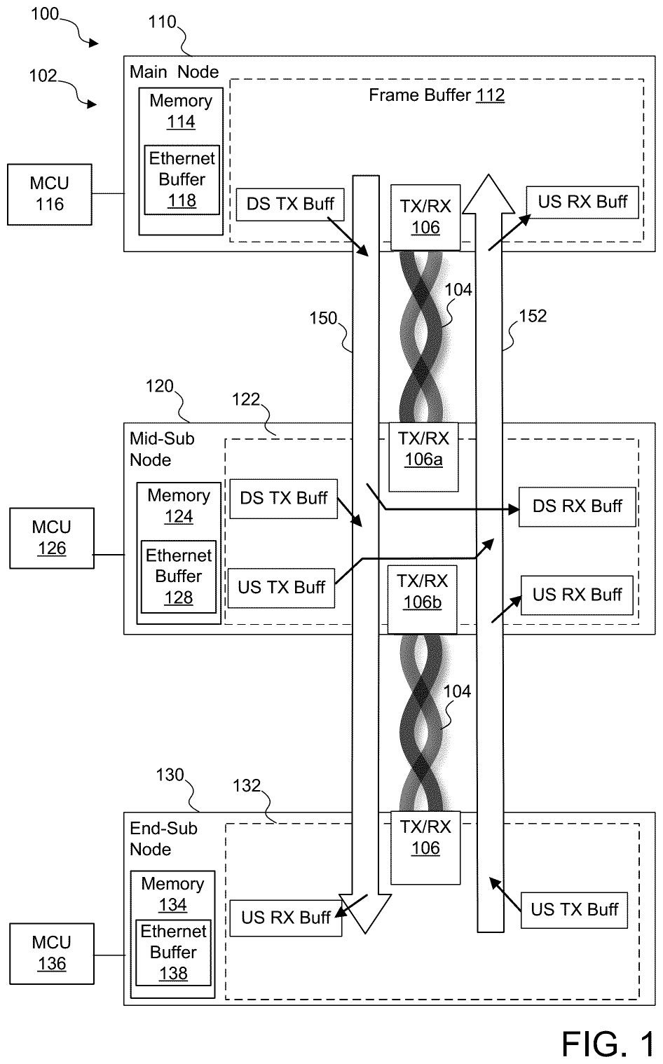

FIG. 1 is a diagram 100 of nodes in a daisy-chain 102. In the daisy-chain 102, each node is connected to a subsequent node via a bus link 104. For example, the bus link 104 may be a twisted pair. As illustrated, the daisy-chain 102 includes a main node 110, one or more mid-sub nodes 120, and an end-sub node 130. In some implementations, each node is a device including one or more modems.

Each node 110, 120, 130 includes a corresponding frame buffer 112, 122, 132. The frame buffers 112, 122, 132 are configured to store information for one or more frames for transmission via the bus links 104 in a downstream direction (from main node 110 toward end-sub node 130) and an upstream direction (from end-sub node 130 toward main node 110). For example, the frame buffer 112 of main node 110 may include an upstream receive buffer (US RX Buff) and a downstream transmit buffer (DS TX Buff). The frame buffer 122 of a mid-sub node 120 may include US RX Buff and a DS TX Buff as well as a downstream receive buffer (DS RX Buff) and an upstream transmit buffer (US TX Buff). The frame buffer 132 of the end-sub node 130 may include a DS RX Buff and an US TX Buff.

Each node 110, 120, 130 further includes one or more transceivers 106 (TX/RX). Each transceiver 106 is configured to generate a signal on a corresponding bus link 104 based on either the contents of the respective frame buffers 112 or 132 or based on the input signal from the other link in a mid-sub node with content that is selectively to be replaced by respective frame buffer 122 locations. In an aspect, the transmission on the bus links 104 are full-duplex. That is the bus links 104 can simultaneously carry a downstream signal and an upstream signal. In some implementations, the communications utilize a carrier-based modulation scheme with echo-cancelation to achieve full-duplexing. For example, the signals may use binary phase shift keying (BPSK), quadrature phase shift keying (QPSK) or Quad Amplitude Modulation (QAM).

In an aspect, the daisy-chain 102 may provide low latency due to no store-and-forward at each node. Data coming from the direction of the main node 110 is immediately forwarded toward the end-sub node 130. Data coming from the direction of the end-sub node 130 is immediately forwarded toward the main node. Each node selectively reads data when the data goes through the node. Each node also selectively changes the data without a store-and-forward of the whole frame or sections of the frame. For example, at a sub-node 120, the transceiver 106a receives a downstream signal 150 and selectively reads data to the DS RX buffer. The transceiver 106b selectively changes data in the downstream signal 150 (e.g., based on DS TX buffer and immediately forwards the downstream signal 150 toward end-sub node 130. Simultaneously, the transceiver 106b receives an uplink signal 152 and selectively reads data to the US RX buffer. The transceiver 106a selectively changes data in the upstream signal 152 and immediately forwards the upstream signal 152 toward main node 110. Accordingly, the frame buffer 122 does not store an entire frame before forwarding the frame to a next node, thereby providing low-latency communications. For example, data may be forwarded from the main node 110 to the end-sub node 130 within less than half of one sampling period, which may be, for example, 10.4 microseconds (μs).

In an aspect, the communications are synchronized according to a superframe structure. For example, the superframes may be transmitted on a 48 kHz cycle with each superframe being 20.82 μs. The payload in each frame may be 256 bytes for a data rate of 98.304 Mbps. Further details of synchronization and the frame structure are described below.

Additionally, each node may include a respective memory 114, 124, 134 for storing configuration information for the node. In some implementations, the memory 114, 124, 134 is an addressable register, a one-time programmable (OTP) memory, or an electronically erasable programmable memory (EEPROM) that stores an identifier of the node. In some implementations, the order of the nodes is flexible and a position of the node within the daisy-chain 102 may be determined during a discovery procedure based on the stored identifier.

In some implementations, one or more nodes may include or be connected to a respective microcontroller, microprocessor, or DSP (MCU) 116, 126, 136. For example, the MCU 116, 126, 136 may be connected to a node via a time division multiplexed (I2S/TDM) connection, Inter-Integrated Circuit (I²C), serial peripheral interface (SPI), or media-independent interface (MII). The MCU 116, 126, 136 may configure the respective node as well as communicate with the other nodes via the daisy-chain 102. For example, in an audio system, an audio source may originate from the DSP (MCU) in a main node 110. Some sub nodes 120 such as intelligent amplifiers may include an MCU, but other nodes such as subwoofers or microphone nodes may not include an MCU.

In some implementations, Ethernet frames are communicated between the MCU and the modem via the SPI connection. The SPI connection may carry: IP packets only or Ethernet frames with or without preamble bytes. The SPI connection requires no Ethernet HW support in the MCU. The memories 114, 124. 134 may each include a respective Ethernet buffer 128 for layer 2 Ethernet frames or chunks of an Ethernet frame. In some implementations, a node 110, 120, 130 may verify an Ethernet frame (e.g., by checking a cyclic redundancy check)

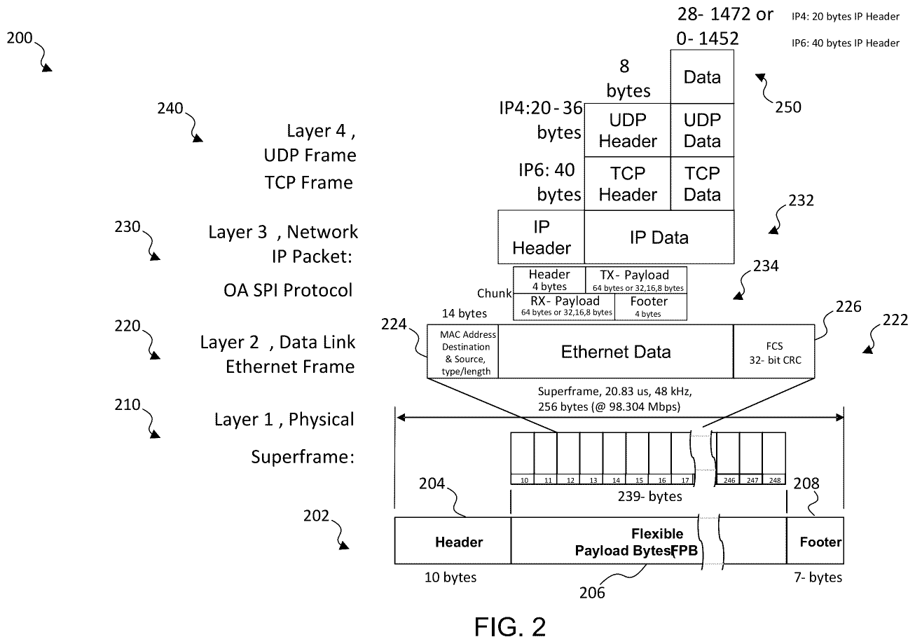

FIG. 2 is a diagram 200 of communication layers with a daisy-chain as the physical layer. The layers refer to the lower layers (i.e., 1-4) of the Open Systems Interconnection (OSI) model and the Internet protocol suite. For simplicity, the higher layers may provide data 250.

At the fourth layer 240, either user datagram protocol (UDP) or transport control protocol (TCP) may divide the data 250 into frames including a respective UDP header or TCP header.

At the third layer 230, an IP packet 232 includes the UDP frame or TCP frame and an IP header. In some implementations, where the SPI connection is used, the OA SPI protocol may divide the IP packet 232 into a chunk 234 including a Header, Tx-Payload, Rx-Payload, and Footer according to the SPI protocol.

At the second layer 220, the SPI chunk 234 (or other chunk of the IP packet) is used to create an ethernet frame 222 including a header 224 with a field for a media access control (MAC) source address, a MAC destination address, a type/length, and/or a virtual local area network (VLAN) identifier. The Ethernet frame 222 also includes a frame check sequence (FCS) field 226, which is a 32-bit cyclic redundancy check (CRC). The layer 2 Ethernet frame 222 is transmitted over the layer 1 physical layer within the flexible payload bytes of a superframe 202. For example, the Ethernet frame 222 may be split into 30 byte segments for transmission at the physical layer 210.

At the first layer 210, which may be the daisy-chain 102 described above, the Ethernet frame 222 is transmitted over one or multiple superframes 202. Each superframe 202 includes a header 204, flexible payload 206, and footer 208. The header 204 includes synchronization and control information for the daisy-chain 102. The footer 208 includes CRC and validity information for the superframe 202. The flexible payload 206 may include up to 239 bytes for a superframe based on a 48 kHz cycle. Some of the bytes of the flexible payload may be assigned to an Ethernet tunnel. For example, in some implementations, 30 bytes of the flexible payload may support a 10 Mbit/s Ethernet tunnel. An Ethernet speed is programmable based on a size of the flexible payload and a data rate of the bus links.

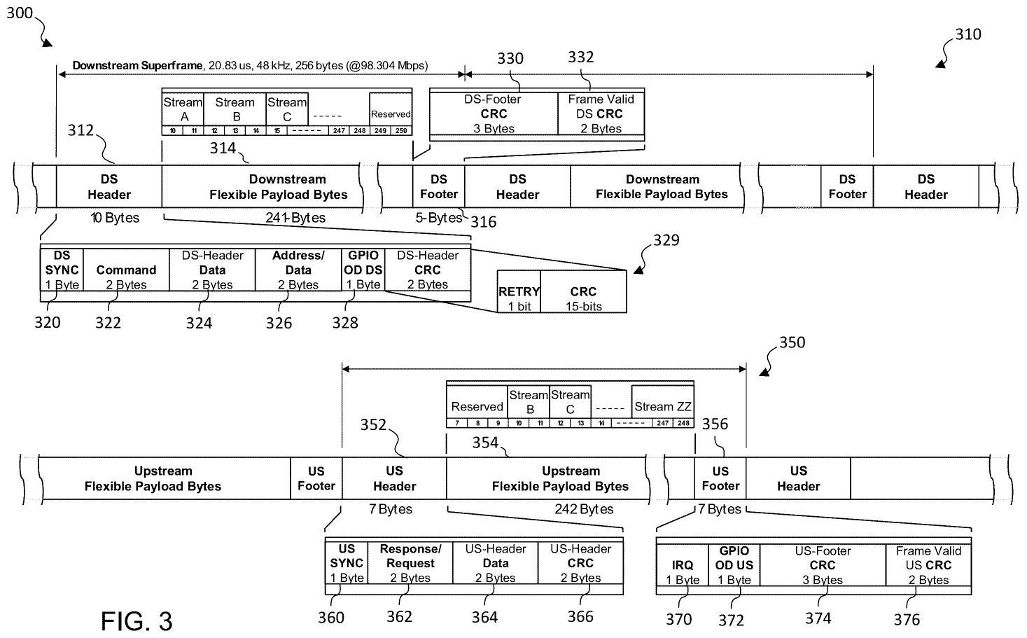

FIG. 3 is a diagram 300 of examples of frame structures. The diagram 300 includes an example of a downstream superframe 310 and an example of an upstream superframe 350.

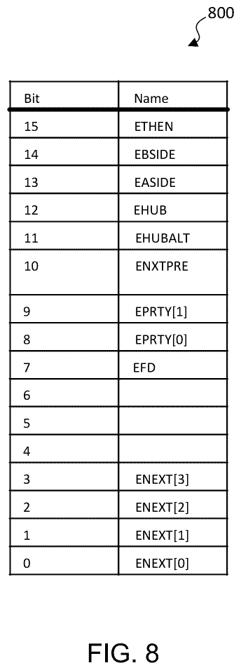

The downstream superframe 310 includes a downstream synchronization header 312, a downstream flexible payload 314, and a downstream footer 316. The downstream synchronization header 312 includes a downstream synchronization byte 320 with a modulo frame counter, a command field 322, data field 324, data or address field 326, GPIO over distance byte 328, retry-bit and CRC 329. The downstream flexible payload 314 includes a plurality of bytes that may be flexibly configured to carry data streams. For example, a stream mapping may indicate which bytes of the downstream flexible payload 314 carry each stream. Further details of the flexible payload 314 are described with respect to FIG. 8. The downstream footer 316 includes a CRC 330 for the downstream flexible payload 314 and a frame valid indication 332 with its own CRC.

The downstream synchronization byte 320 indicates the start of a frame and includes a modulo frame counter value. The command field 322 provides for control signaling and addresses a node. The data field 324 and data or address fields 326 depend on the command field 322. The GPIO over distance byte 328 indicates the status of one or more virtual GPIO pins. The CRC 329 is a CRC of the downstream header 312 including a retry bit and 15 bit CRC. The CRC 330, in the downstream footer 316, provides a CRC for the downstream flexible payload 314.

The frame valid indication 332 is an indication with separate CRC bits that indicates whether the downstream frame was valid when it arrived at the previous node. For example, a sub node may check the CRC 330 and determine that the received flexible payload is not valid. The sub node, however, may have data to transmit on the flexible payload and calculate a new CRC 330. Accordingly, the frame transmitted by the sub node may have a correct CRC 330, but the frame valid indication 332 may indicate that other data in the flexible payload is not valid.

The upstream superframe 350 includes an upstream header 352, an upstream flexible payload 354, and an upstream footer 356. The upstream header 352 includes an upstream synchronization byte 360, a response/request field 362, data field 364, and a header CRC 366. Similar to the downstream flexible payload 314, the upstream flexible payload 354 includes a plurality of bytes that may be flexibly configured to carry data streams. The upstream flexible payload 354 may be defined by the same or different stream map in regards to the downstream stream map and the stream mapping may be different between each node. The upstream footer 356 includes an interrupt request (IRQ) byte 370, a GPIO byte 372, a CRC 374 for the upstream flexible payload 354, and a frame valid indication 376 with its own CRC.

The upstream synchronization byte 360 indicates the start of an upstream superframe 350. The response/request field 362 is a response to a command field 322 or a request for control signaling. Data field 364 is defined based on the response/request field 362. The header CRC 366 is calculated based on the content of the upstream header 352. The interrupt request byte 370 indicates an interrupt request detected at a downstream node. The GPIO byte 372 indicates the status of the one or more virtual GPIO pins at downstream nodes. The CRC 374 is calculated based on the upstream flexible payload 354. The frame valid indication 376 operates in the same manner as the frame valid indication 332 but for the upstream direction. In some cases, a node may not receive an upstream header 352 from a downstream node (e.g., if the downstream node becomes disconnected). The node may generate an upstream frame including a new UpSRH in the absence of a received UpSRH from the downstream node.

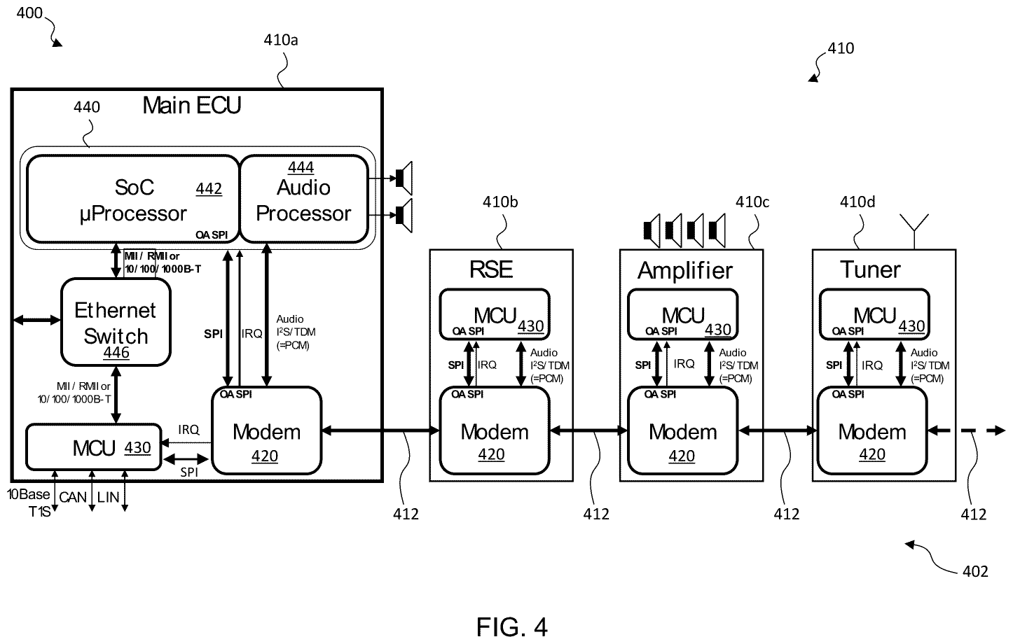

FIG. 4 is a diagram of an example communication system 400 for Ethernet communication over a daisy-chain 402. The communication system 400 includes a plurality of nodes 410 (e.g., nodes 410a, 410b, 410c, and 410d). The nodes 410 are connected by bus links 412, which may be twisted pairs.

In the illustrated example, the communication system 400 is an audio system, for example, within a vehicle. For instance, the first node 410a may be a main electronic control unit (ECU), the second node 410b may be a rear seat entertainment (RSE) device, the third node 410c may be an amplifier, and the fourth node 410d may be a tuner. In an aspect, the daisy-chain 402 provides flexible node ordering for connecting the nodes in any order, for instance, based on the physical configuration of the vehicle. In some implementations, the daisy-chain 402 carries audio streams for the communication system 400 (for example, using assigned bytes of the flexible payload 206). An Ethernet tunnel may provide communications among the nodes for software updates or diagnostics, for example.

In an aspect, each node 410 includes a modem 420 that controls the communications on the daisy-chain 402. For example, the modem 420 may include the frame buffer 112 and memory 114. Additionally, each node 410 includes an MCU 430. The MCU 430 is connected to the modem, for example, via an SPI interface 422. In some implementations, the MCU 430 may also be connected via an interrupt request (IRQ) connection. In some implementations, the MCU 430 may also be connected via an audio connection such as I²S/TDM or PCM.

In some implementations, the main ECU (e.g., first node 410a) may include a system on chip (SoC) 440 including a SoC microprocessor 442 and an audio processor 444. The SoC 440 may additionally or alternatively be connected to the modem 420 via an SPI connection and/or IRQ. The main ECU may also include an Ethernet switch 446. The first node 410a may be considered a hub node that has priority for transmitting Ethernet frames on the daisy-chain 402.

In an aspect, the daisy-chain 402 carries the Ethernet frames in the flexible payload 206 to nodes that are configured to participate in an Ethernet tunnel. For example, a node may dynamically indicate participation in a tunnel by setting a register. Not every node which an Ethernet tunnel traverses has to participate in the Ethernet tunnel. For example, a node may simply forward the flexible payload at the physical layer. Such a node does not need an MCU. Such nodes may not even know that an Ethernet tunnel goes through them (e.g. if the system is configured by the main node only).

Each sub-node in the system 400 that participates in the Ethernet tunnel can be addressed and answers to TCP/IP. Multiple sub nodes are Ethernet addressable. In a half-duplex mode, frames may be sent as Broadcast, Multicast, or Unicast. In a full-duplex point-to-point mode, two nodes may concurrently transmit Ethernet frames in opposite directions. In an aspect, a node 410 may filter Ethernet frames at the modem 420 or at the MCU 430. In some implementations, the modem 420 may handle all Ethernet processing. For example, the modem 420 may receive data from the MCU 430 and generate an Ethernet frame by adding the header 224 and the FCS field 226. Similarly, the modem 420 may receive an Ethernet frame on a bus link 412, check the CRC. The modem 420 may filter the Ethernet frame based on one or more fields of the header 224, then send the relevant data to the MCU 430 when the Ethernet frame is for the node. Alternatively, the modem 420 may forward all received Ethernet frames to the MCU 430 for filtering.

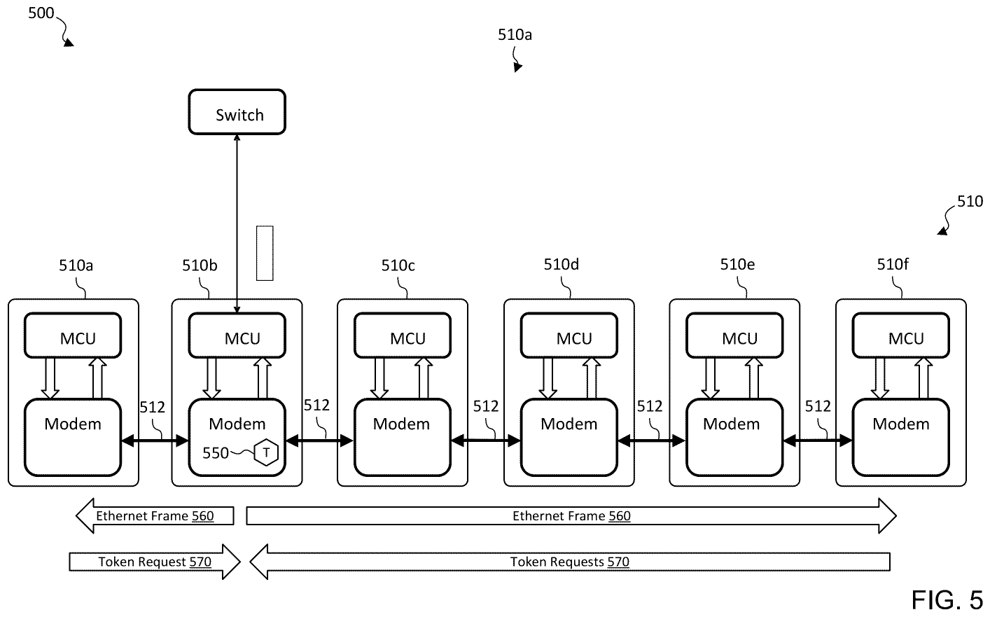

FIG. 5 is a diagram 500 of token management in a daisy-chain 502 for Ethernet communication in the half-duplex mode. Similar to the daisy-chain 402, the daisy-chain 502 includes a plurality of nodes 510, each having a MCU and a modem connected to an adjacent node in an upstream direction and/or a downstream direction via a bus link 512. The bus links allow for full-duplex synchronous communications over superframes. As illustrated, each of the nodes 510 is configured to participate in the Ethernet tunnel; however, a node that does not have Ethernet traffic may be configure without the Ethernet tunnel. It is also possible that the nodes 510 participate in different Ethernet tunnels by configuring different bytes in the flexible payload for different Ethernet tunnels.

When a node transmits an Ethernet frame on the daisy-chain 502 as unicast, multicast, or broadcast, the Ethernet frame may be transmitted in both the upstream direction and the downstream direction (except for the main-node and end-sub-node) in order to reach all of the nodes. Because both the upstream direction and the downstream direction are utilized for an Ethernet frame transmission, only one node can transmit an Ethernet frame at a time (i.e., in the same superframe(s)). In an aspect, a transmit token 550 indicates the node 510 that is allowed to transmit. For example, as illustrated, the node 510b, which may be a switch node, has the token 550 and is transmitting an Ethernet frame 560 upstream towards a main-node 510a and downstream towards an end-sub-node 510f.

In an aspect, because the direction opposite the Ethernet frame does not carry the Ethernet frame data, the flexible payload 206 in the opposite direction may carry signaling information. In particular, the nodes that do not have the token may transmit a token request 570 in the direction opposite the Ethernet frame 560 due to the full-duplex nature of the bus links 512. Multiple token requests 570 may be multiplexed in the direction opposite the Ethernet frame 560. For instance, each node may have an assigned byte within the flexible payload for indicating an Ethernet Priority Access Number (EPRAN) for the token request 570.

When a node finishes transmitting an Ethernet frame 560, the node may pass the token to another node based on an order of priority. In an aspect, the order of priority, when a type of node is present in the plurality of nodes, is: 1) a hub node that holds the transmit token; 2) a hub node without the transmit token; 3) a designated high priority node indicated in the request; and 4) a node that transmitted the request with a number (e.g., EPRAN) indicating that the node was first to request the token for a new Ethernet frame. When the daisy-chain 502 does not include a type of node (e.g., a designated high priority node), that type of node is skipped in the priority order. For example, in some implementations, a mechanism for a designated high priority node may not be implemented or may be disabled, but the order of priority may still be valid.

A hub node (e.g., node 510b) may be configured for token holding, where the hub node may keep the transmit token 550 after finishing an Ethernet frame if the hub node has another frame to transmit (i.e., priority 1). If the hub node is not configured for token holding, the hub node will transmit the token to another node based on priority. If another node has the transmit token 550 and finishes an Ethernet frame, the other node will send the token to the hub node if the hub node has requested the token (i.e., priority 2). A node may request a priority transmission, for example, for control signaling via the token request 570. If the hub node has not requested the transmit token 550, the node that has finished the Ethernet frame will pass the token to the node that has indicated a priority transmission (priority 3). If the hub node has not requested the transmit token 550 and there is no priority transmission, the node that has finished the Ethernet frame will pass the transmit token 550 based on the EPRAN indicated in the token requests. In some cases, nodes that have data to transmit during the same Ethernet frame may assign the same EPRAN to the data based on a greatest EPRAN (GEPRAN) transmitted in the frame. For example, each node may derive the EPRAN by incrementing the GEPRAN. In some implementations, the amount of the increment may be programmable per node. In some implementations, the GEPRAN is circular and the node with the token selects the node that reported the EPRAN with the smallest circular distance from the GEPRAN to the EPRAN. A tie-breaker may select among nodes with the same EPRAN. For example, the tie-breaker may go to the closest node to the transmit token 550, or closest node to the main node 510a or other pre-selected node 510 or may be randomly selected.

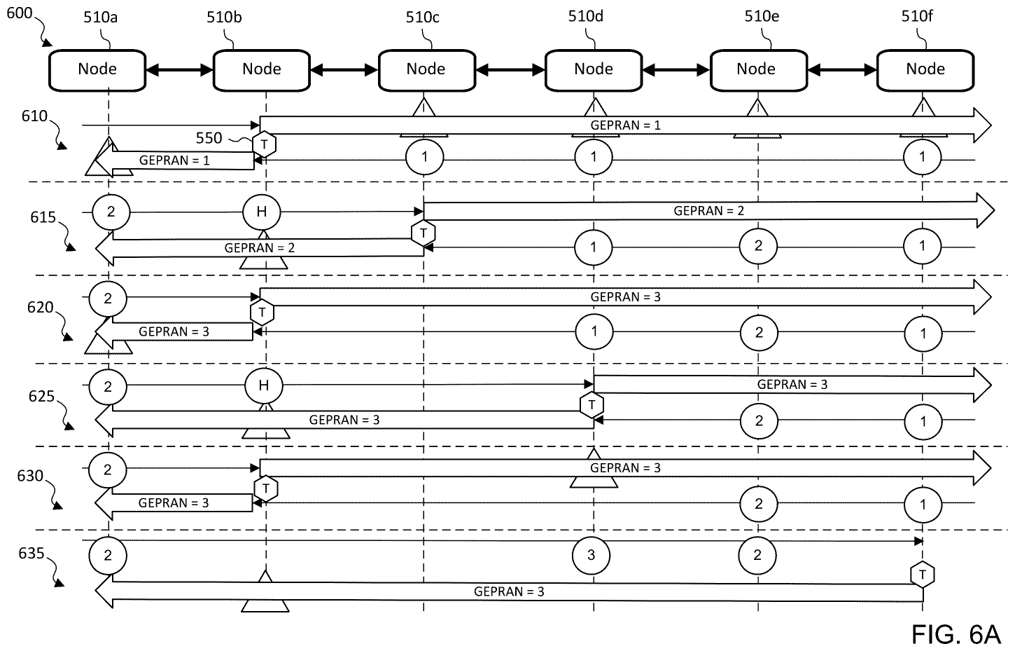

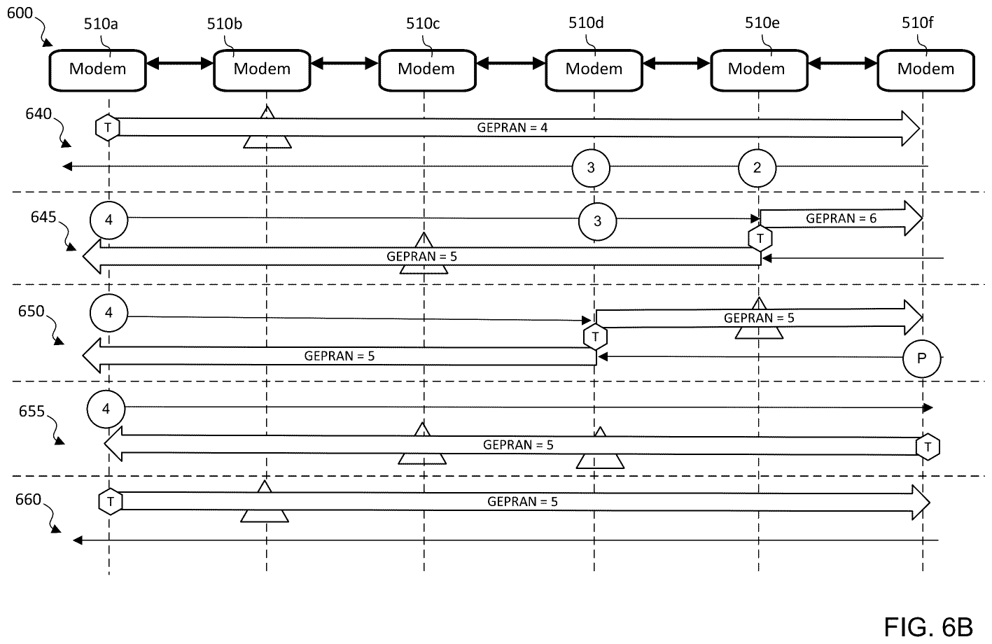

FIGS. 6A and 6B show token management for an example series of exchanges that may be transmitted among the nodes 510. Each exchange may include transmission of an Ethernet frame and token requests. A triangle indicates the node(s) that receive the Ethernet Frame. The circles indicate a token request and priority or EPRAN, As in FIG. 5, the node 510b may be a hub node.

In exchange 610, the node 510b has a broadcast frame to transmit. The node 510 transmits the frame both upstream and downstream, and each of the other nodes receives the frame. The frame indicates a GEPRAN of 1. The nodes 510c and 510d have data to transmit, for example, in response to the frame, and indicate a token request and assign the GEPRAN of 1 to the requests. At the end of the frame, the node 510b passes the transmit token 550 to the node 510c based on lack of hub frame, no priority request, and the tie-breaker (closest node to main node 510a).

In exchange 615, the node 510c transmits a unicast frame with a GEPRAN of 2 (incremented because of the token requests with EPRAN=1). Although only node 510b in the upstream direction from node 510c receives the unicast frame, the node 510c may transmit the unicast frame in both directions. The nodes 510a and 510e may have data to transmit, for example, due to a delayed response to the broadcast frame in exchange 610. Because the GEPRAN of the current frame is 2, the nodes 510a and 510e may assign an EPRAN of 2 to the data and indicate a token request. Additionally, the node 510b may have data to transmit and may indicate a token request with a hub priority (H). The node 510b receives the token based on being a hub node without the transmit token.

In exchange 620, the node 510b transmits a unicast frame to the node 510a and indicates a GEPRAN of 3 (incremented from the EPRAN of 2). The EPRAN of 1 indicated by nodes 510d and 510f now have shortest circular distance, so the token is sent to node 510d based on the tie-breaker.

In exchange 625, the node 510d transmits a unicast frame to node 510b with a GEPRAN of 3. The EPRAN of 1 indicated by node 510f is now the lowest EPRAN, but the hub node 510b still has data to transmit, so the node 510d sends the token to the hub node 510b.

In exchange 630, the node 510b transmits a unicast frame to node 510d with a GEPRAN of 3. The EPRAN of 1 indicated by node 510f is now the lowest EPRAN, so the node 510b sends the token to the node 510f.

In exchange 635, the node 510f transmits a unicast frame to the node 510b and indicates a GEPRAN of 3. The node 510d also has data to transmit and assigns an EPRAN of 3 based on the GEPRAN. Nodes 510a and 510e indicate the same EPRAN of 2, and the hub node 510b has no data to transmit, so the node 510f sends the token to node 510a based on a tie-breaker.

In exchange 640, the node 510a transmits a unicast frame to the node 510c with a GEPRAN of 4, after incrementing. The node 510a passes the token to the node 510e with the lowest EPRAN of 2. The node 510a has additional data to transmit, so the node 510a assigns the additional data an EPRAN of 4.

In exchange 645, the node 510e transmits a unicast frame to the node 510c with a GEPRAN of 5, then passes the token to the node 510d with the lowest EPRAN of 3.

In exchange 650, the node 510d transmits a unicast frame to the node 510e with a GEPRAN of 5. The node 510f indicates a new priority transmission (P). Accordingly, the node 510d passes the token to the node 510f.

In exchange 655, the node 510f transmits a multicast frame to nodes 510c and 510d with a GEPRAN of 5. The node 510f sends the token to the node 510a, which is the only node indicating a token request with a EPRAN of 4.

In exchange 660, the node 510 transmits a unicast frame to the node 510b.

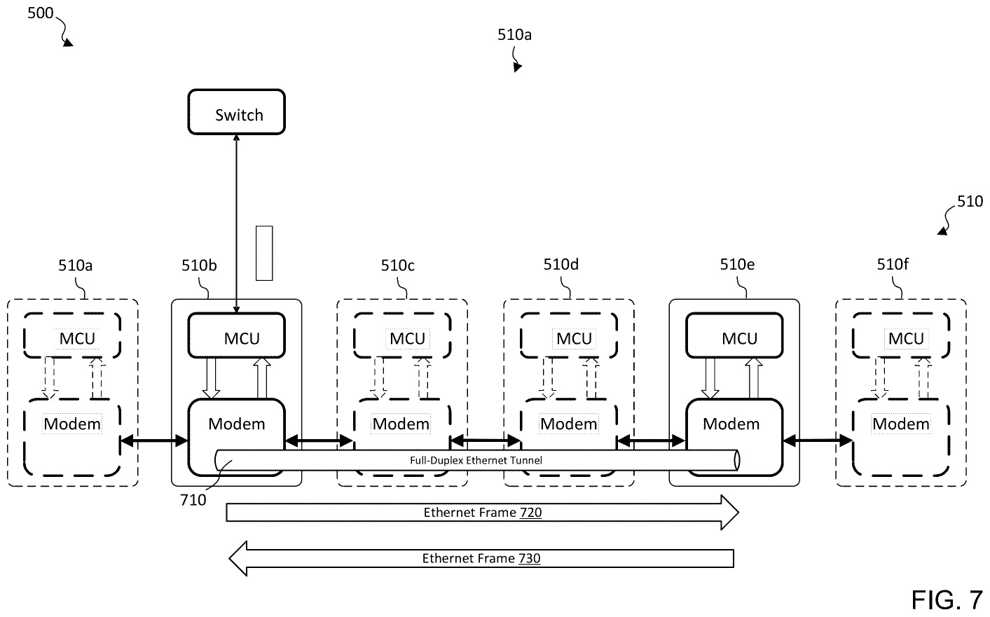

FIG. 7 is a diagram 700 of a full-duplex point-to-point configuration for Ethernet tunneling on the daisy-chain 502. The full-duplex point-to-point configuration may be used when only two nodes need to communicate Ethernet frames. For example, a full-duplex Ethernet tunnel 710 may be configured between node 510b and node 510e. The other nodes of the daisy-chain 502 are still connected and communicate the superframes on the bus links, but the other nodes do not read or write the flexible payload bytes for the full-duplex Ethernet tunnel. The node 510b transmits Ethernet frames in the downstream direction, and node 510e transmits Ethernet frames in the upstream direction. No token is needed for transmission because the full-duplex bus links allow concurrent transmissions in opposite directions.

FIG. 8 is a diagram of an example configuration register 800 for an Ethernet tunnel. The configuration register 800 may be programmed by the MCU of the respective node or via control signaling in superframes.

The ETHEN bit enables a node to participate in Ethernet traffic if set to 1. Also resets GEPRAN, EREQ and ETOKEN. Should be broadcast.

The EBSIDE bit indicates whether an Ethernet BSIDE (downstream) tunnel is enabled. The bit set to 1 indicates to listen to downstream (B-side) side for (upstream moving) data. The node uses Ethernet tunnel downstream (B-side) for data to be sent when the node has the token. When the bit is set to 0, the node ignores B-side Ethernet tunnel. If EBSIDE is 1 and EASIDE is 0 then this Node will start with owning the Token and it is configured as the Ethernet endpoint closest to the main node.

The EHUB bit indicates Ethernet Hub Functionality. If the EHUB bit is set then every access request will be granted to this node.

The EHUBALT bit indicates whether the Ethernet Hub alternates between using transmit opportunities and granting the Token to other nodes for their transmission of Ethernet frames if set to 1. If the EHUBALT bit is set to 0 then Ethernet Hub will hold the Token as long it has pending Ethernet frames. This bit is only relevant if EHUB is set to 1.

The EASIDE bit indicates whether the Ethernet ASIDE (upstream facing) tunnel is enabled. If the EASIDE bit is set to 1, the node listens to upstream (A-side) side for (downstream moving) data. The node uses ethernet tunnel upstream (A-side) for data to be sent when the node has the token. If the EASIDE bit is set to 0, the node ignores the A-side ethernet tunnel. EASIDE bit is set to 1 and EBSIDE bit is set to 0 indicates the endpoint of the Ethernet tunnel further away from the main node.

In some implementations, the register 800 may include 1 or more bits indicating whether the node is an upstream end-node of the tunnel, a downstream end-node of the tunnel, or a mid-node of the tunnel.

The ENXTPRE bit indicates a priority node. If the ENXTPRE bit is set, and the node defined in the ENEXT bit field requests Token access, then the Token advances to the node defined in the ENEXT node. The priority node has the highest priority over all other Token requests.

The EPRTY[1:0] bits changes the decrement step of EPRAN to gain higher priority. In some implementations, the priority may also be influenced directly by OA SPI header.

The EFD bit indicates Full-duplex Mode if set to 1. The full-duplex mode is described above with respect to FIG. 7. In Full-duplex Mode the ENEXT fields of two nodes point at each other.

The ENEXT [3:0] bits are an Ethernet next node ID bit field. The ENEXT bits hold the ID for the pre-defined next node. For example, the NEXT bits cab be used for Token-Ring configuration, for pointing back to a hub or for point-to-point Ethernet Traffic configuration.

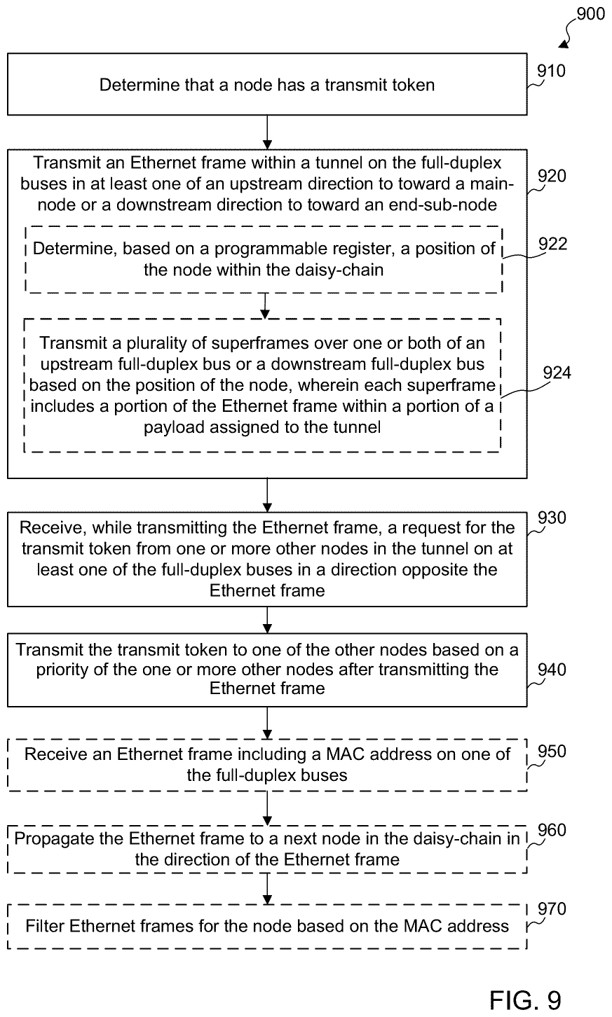

FIG. 9 is a flowchart of an example method 900 performed by a node 510 in a daisy-chain 502. The method 900 may communicate Ethernet frames in an Ethernet tunnel among the nodes in the daisy-chain 502. The method 900 may be performed in communication with another node 510 in the daisy-chain 102.

In block 910, the method 900 includes determining that a node has a transmit token. For example, in some implementations, the node 510b may determine that the node has a transmit token. In some implementations, a main-node may determine that the main-node initially has the transmit token based on a configuration of a register, for example, when EBSIDE is 1 and EASIDE is 0 indicating the main-node is the first node.

In block 920, the method 900 includes transmitting an Ethernet frame within a tunnel on the full-duplex bus links in at least one of an upstream direction to toward a main-node 510a or a downstream direction to toward an end-sub-node 510f. For example, in some implementations, the node 510b may transmit an Ethernet frame 560 within a tunnel on the full-duplex bus links 412 in at least one of an upstream direction to toward a main-node or a downstream direction to toward a end-sub-node. In some implementations, in sub-block 922, the block 920 may optionally include determining, based on a programmable register, a position of the node within the daisy-chain 502. In some implementations, in sub-block 924, the block 920 may optionally include transmitting a plurality of superframes 202 over one or both of an upstream full-duplex bus link or a downstream full-duplex bus link based on the position of the node. Each superframe 202 includes a portion of the Ethernet frame 222 within a portion of a payload 206 assigned to the tunnel.

In block 930, the method 900 includes receiving, while transmitting the Ethernet frame, a request for the transmit token from one or more other nodes in the tunnel on at least one of the full-duplex bus links in a direction opposite the Ethernet frame. For example, in some implementations, the node 510b may receive, while transmitting the Ethernet frame 560, a request 570 for the transmit token 550 from one or more other nodes in the tunnel on at least one of the full-duplex bus links 412 in a direction opposite the Ethernet frame.

In block 940, the method 900 includes transmitting the transmit token to one of the other nodes based on a priority of the one or more other nodes after transmitting the Ethernet frame. For example, in some implementations, the node 510b may transmit the transmit token 550 to one of the other nodes based on a priority of the one or more other nodes after transmitting the Ethernet frame.

In block 950, the method 900 may optionally include receiving an Ethernet frame including a MAC address on one of the full-duplex bus links. For example, in some implementations, the node 510b may receive an Ethernet frame including a MAC address on one of the full-duplex bus links.

In block 960, the method 900 may optionally include propagating the Ethernet frame to a next node in the daisy-chain in the direction of the Ethernet frame. For example, in some implementations, the node 510b may propagate the Ethernet frame to a next node in the daisy-chain in the direction of the Ethernet frame.

In block 970, the method 900 may optionally include filtering Ethernet frames for the node based on the MAC address. For example, in some implementations, the node 510b may filter Ethernet frames for the node based on the MAC address.

Example aspects are described in the following numbered clauses:

Clause 1. A method of transmitting Ethernet frames over a plurality of nodes connected in a daisy-chain over full-duplex bus links, the method comprising: determining that a node has a transmit token; transmitting an Ethernet frame within a tunnel on the full-duplex bus links in at least one of an upstream direction toward a main-node or a downstream direction toward an end-sub-node; receiving, while transmitting the Ethernet frame, a request for the transmit token from one or more other nodes in the tunnel on at least one of the full-duplex bus links in a direction opposite the Ethernet frame; and transmitting the transmit token to a next node of the other nodes based on an order of priority of the one or more other nodes after transmitting the Ethernet frame.

Clause 2. The method of clause 1, wherein the order of priority from highest priority to lowest priority, when a type of node is present in the plurality of nodes, is: a hub node that holds the transmit token; a hub node without the transmit token; a designated high priority node indicated in the request; and a node that transmitted the request with a number indicating that the node was first to request the token for a new Ethernet frame.

Clause 3. The method of clause 2, wherein when requests from multiple nodes indicate a same number, the next node is selected based on a distance to the node with the transmit token.

Clause 4. The method of clause 2 or 3, wherein the number in the request is selected as a circularly incremented value of a token counter transmitted by the node with the token, and the next node has a smallest circular distance between the number in the request and the token counter.

Clause 5. The method of any of clauses 1-4, further comprising: receiving an Ethernet frame on one of the full-duplex bus links, the Ethernet frame having a header including a field for one or more of: a media access control (MAC) address, an Ethernet type, or a virtual local area network; propagating the Ethernet frame to a next node in the daisy-chain in the direction of the Ethernet frame; and filtering Ethernet frames for the node based on the field of the header.

Clause 6. The method of any of clauses 1-5, wherein the one or more other nodes in the tunnel include a subset of the plurality of nodes connected in the daisy-chain that have dynamically indicated participation in the tunnel.

Clause 7. The method of any of clauses 1-6, wherein each node includes a programmable register defining one or more of: participation in Ethernet traffic; downstream Ethernet tunnel enablement; whether the node is a hub node; whether the node is an upstream end-node of the tunnel, a downstream end-node of the tunnel, or a mid-node of the tunnel; whether the hub node transmits the token when the hub node has other Ethernet frames to transmit; upstream Ethernet tunnel enablement; whether the next node is a high priority node; a counter decrement level; a point-to-point indication; or an identifier of the next node.

Clause 8. The method of any of clauses 1-7, wherein transmitting the Ethernet frame within the tunnel on the full-duplex bus links at least one of an upstream direction to a main-node or a downstream direction to a sub-node comprises: determining, based on a programmable register, a position of the node within the daisy-chain; and transmitting a plurality of superframes over one or both of an upstream full-duplex bus link or a downstream full-duplex bus link based on the position of the node, wherein each superframe includes a portion of the Ethernet frame within a portion of a payload assigned to the tunnel.

Clause 9. A node for transmitting Ethernet frames over a plurality of nodes connected in a daisy-chain over full-duplex bus links, the node including a transceiver configured to: determine that the node has a transmit token; transmit an Ethernet frame within a tunnel on the full-duplex bus links at least one of an upstream direction towards a main-node or a downstream direction towards an end-sub-node; receive, while transmitting the Ethernet frame, a request for the transmit token from one or more other nodes in the tunnel on at least one of the full-duplex bus links in a direction opposite the Ethernet frame; and transmit the transmit token to a next node of the other nodes based on an order of priority of the one or more other nodes.

Clause 10. The node of clause 9, further comprising a microcontroller configured to communicate with the transceiver via a serial peripheral interface or media-independent interface.

Clause 11. The node of clause 10, wherein the transceiver comprises a buffer configured to store at least one Ethernet frame for transmission or reception without communication with the microcontroller.

Clause 12. The node of clause 10 or 11, wherein the transceiver is configured to: receive data from the microcontroller; and generate the Ethernet frame including a cyclic redundancy check (CRC) sequence based on the data.

Clause 13. The node of any of clauses 10-12, wherein the transceiver is configured to check a CRC sequence on a received Ethernet frame prior to sending the Ethernet frame to the microcontroller.

Clause 14. The node of clause 10, wherein the transceiver is configured to send a content of a flexible payload for the Ethernet tunnel to the microcontroller for filtering based on a MAC address.

Clause 15. The node of any of clauses 9-14, wherein the order of priority from highest priority to lowest priority, when a type of node is present in the plurality of nodes, is: a hub node that holds the transmit token; a hub node without the transmit token; a designated high priority node indicated in the request; and a node that transmitted the request with a number indicating that the node was first to request the token for a new Ethernet frame.

Clause 16. The node of clause 15, wherein when requests from multiple nodes indicate a same number, the next node is selected based on a distance to the node with the transmit token.

Clause 17. The node of clause 15 or 16, wherein the number in the request is selected as a circularly incremented value of a token counter transmitted by the node with the token, and the next node has a smallest circular distance between the token counter and the number in the request and.

Clause 18. The node of any of clauses 9-17, wherein the transceiver is configured to: receive an Ethernet frame including a media access control (MAC) address on one of the full-duplex bus links; propagate the Ethernet frame to a next node in the daisy-chain in the direction of the Ethernet frame; and filter Ethernet frames for the node based on the MAC address.

Clause 19. The node of any of clauses 9-18, wherein the one or more other nodes in the tunnel include a subset of the plurality of nodes connected in the daisy-chain.

Clause 20. The node of any of clauses 9-19, comprising a programmable register defining one or more of: participation in Ethernet traffic; downstream Ethernet tunnel enablement; whether the node is a hub node; whether the hub node transmits the token when the hub node has other Ethernet frames to transmit; whether the node is an upstream end-node of the tunnel, a downstream end-node of the tunnel, or a mid-node of the tunnel; upstream Ethernet tunnel enablement; whether the next node is a high priority node; a counter decrement level; a point-to-point indication; and an identifier of the next node.

Clause 21. The node of any of clauses 9-20, wherein to transmit the Ethernet frame within the tunnel on the full-duplex bus links at least one of an upstream direction to a main-node or a downstream direction to a sub-node, the transceiver is configured to: determine, based on a programmable register, a media access control (MAC) address of the node within the daisy-chain; and transmit a plurality of superframes over one or both of an upstream full-duplex bus link or a downstream full-duplex bus link based on the MAC address of the node, wherein each superframe includes a portion of the Ethernet frame within a portion of a payload assigned to the tunnel.

Clause 22. A communication system comprising: a plurality of nodes connected in a daisy-chain via respective bus links, wherein the plurality of nodes are configured for full-duplex, synchronized communication via a carrier-based modulation scheme over the bus links for transmission of superframes including a flexible payload, wherein to transmit Ethernet frames for an Ethernet tunnel among the plurality of nodes, a respective node of the Ethernet tunnel is configured to: determine, based on a programmable register, a media access control (MAC) address of the respective node within the daisy-chain; and transmit a plurality of superframes over one or both of an upstream full-duplex bus link or a downstream full-duplex bus link based on the MAC address of the node, wherein each superframe includes a portion of the Ethernet frame within a portion of the flexible payload assigned to the tunnel.

Clause 23. The communication system of clause 22, wherein the programmable register defines one or more of: participation in Ethernet traffic; downstream Ethernet tunnel enablement; whether the node is a hub node; whether the hub node transmits a token when the hub node has other Ethernet frames to transmit; upstream Ethernet tunnel enablement; whether a next node is a high priority node; a counter decrement level; a point-to-point indication; and an identifier of the next node.

Clause 24. The communication system of clause 22, wherein the programmable register indicates a point-to-point tunnel between two of the nodes, and wherein each node of the point-to-point tunnel is configured to transmit Ethernet frames to the other node within the flexible payload of the superframes in a direction of the other node on the full-duplex bus links.

Clause 25. The communication system of clause 22, wherein the Ethernet tunnel includes three or more nodes, and wherein each node is configured to: determine that the node has a transmit token; transmit an Ethernet frame within a tunnel on the full-duplex bus links at least one of an upstream direction towards a main-node or a downstream direction towards an end-sub-node; receive, while transmitting the Ethernet frame, a request for the transmit token from one or more other nodes in the tunnel on at least one of the full-duplex bus links in a direction opposite the Ethernet frame; and transmit the transmit token to one of the other nodes based on a priority of the one or more other nodes.

Clause 26. The communication system of clause 22, wherein an Ethernet speed is programmable based on a size of the flexible payload and a data rate of the bus links.

By way of example, an element, or any portion of an element, or any combination of elements may be implemented with a “processing system” that includes one or more processors. Examples of processors include microprocessors, microcontrollers, digital signal processors (DSPs). field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, scripts, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. Non-transitory computer-readable media excludes transitory signals.

1. A method of transmitting Ethernet frames over a plurality of nodes connected in a daisy-chain over full-duplex bus links, the method comprising:
determining that a node has a transmit token;
transmitting an Ethernet frame within a tunnel on the full-duplex bus links in at least one of an upstream direction toward a main-node or a downstream direction toward an end-sub-node;
receiving, while transmitting the Ethernet frame, a request for the transmit token from one or more other nodes in the tunnel on at least one of the full-duplex bus links in a direction opposite the Ethernet frame; and
transmitting the transmit token to a next node of the other nodes based on an order of priority of the one or more other nodes after transmitting the Ethernet frame.

2. The method of claim 1, wherein the order of priority from highest priority to lowest priority, when a type of node is present in the plurality of nodes, is:
a hub node that holds the transmit token;
a hub node without the transmit token;
a designated high priority node indicated in the request; and
a node that transmitted the request with a number indicating that the node was first to request the token for a new Ethernet frame.

3. The method of claim 2, wherein when requests from multiple nodes indicate a same number, the next node is selected based on a distance to the node with the transmit token.

4. The method of claim 2, wherein the number in the request is selected as a circularly incremented value of a token counter transmitted by the node with the token, and the next node has a smallest circular distance between the number in the request and the token counter.

5. The method of claim 1, further comprising:
receiving an Ethernet frame on one of the full-duplex bus links, the Ethernet frame having a header including a field for one or more of: a media access control (MAC) address, an Ethernet type, or a virtual local area network;
propagating the Ethernet frame to a next node in the daisy-chain in the direction of the Ethernet frame; and
filtering Ethernet frames for the node based on the field of the header.

6. The method of claim 1, wherein the one or more other nodes in the tunnel include a subset of the plurality of nodes connected in the daisy-chain that have dynamically indicated participation in the tunnel.

7. The method of claim 1, wherein each node includes a programmable register defining one or more of:
participation in Ethernet traffic;
downstream Ethernet tunnel enablement;
whether the node is a hub node;
whether the node is an upstream end-node of the tunnel, a downstream end-node of the tunnel, or a mid-node of the tunnel;
whether the hub node transmits the token when the hub node has other Ethernet frames to transmit;
upstream Ethernet tunnel enablement;
whether the next node is a high priority node;
a counter decrement level;
a point-to-point indication; or
an identifier of the next node.

8. The method of claim 1, wherein transmitting the Ethernet frame within the tunnel on the full-duplex bus links at least one of an upstream direction to a main-node or a downstream direction to a sub-node comprises:
determining, based on a programmable register, a position of the node within the daisy-chain; and
transmitting a plurality of superframes over one or both of an upstream full-duplex bus link or a downstream full-duplex bus link based on the position of the node, wherein each superframe includes a portion of the Ethernet frame within a portion of a payload assigned to the tunnel.

9. A node for transmitting Ethernet frames over a plurality of nodes connected in a daisy-chain over full-duplex bus links, the node including a transceiver configured to:
determine that the node has a transmit token;
transmit an Ethernet frame within a tunnel on the full-duplex bus links at least one of an upstream direction towards a main-node or a downstream direction towards an end-sub-node;
receive, while transmitting the Ethernet frame, a request for the transmit token from one or more other nodes in the tunnel on at least one of the full-duplex bus links in a direction opposite the Ethernet frame; and
transmit the transmit token to a next node of the other nodes based on an order of priority of the one or more other nodes.

10. The node of claim 9, further comprising a microcontroller configured to communicate with the transceiver via a serial peripheral interface or media-independent interface.

11. The node of claim 10, wherein the transceiver comprises a buffer configured to store at least one Ethernet frame for transmission or reception without communication with the microcontroller.

12. The node of claim 10, wherein the transceiver is configured to:
receive data from the microcontroller; and
generate the Ethernet frame including a cyclic redundancy check (CRC) sequence based on the data.

13. The node of claim 10, wherein the transceiver is configured to check a CRC sequence on a received Ethernet frame prior to sending the Ethernet frame to the microcontroller.

14. The node of claim 10, wherein the transceiver is configured to send a content of a flexible payload for the Ethernet tunnel to the microcontroller for filtering based on a MAC address.

15. The node of claim 9, wherein the order of priority from highest priority to lowest priority, when a type of node is present in the plurality of nodes, is:
a hub node that holds the transmit token;
a hub node without the transmit token;
a designated high priority node indicated in the request; and
a node that transmitted the request with a number indicating that the node was first to request the token for a new Ethernet frame.

16. The node of claim 15, wherein when requests from multiple nodes indicate a same number, the next node is selected based on a distance to the node with the transmit token.

17. The node of claim 15, wherein the number in the request is selected as a circularly incremented value of a token counter transmitted by the node with the token, and the next node has a smallest circular distance between the token counter and the number in the request and.

18. The node of claim 9, wherein the transceiver is configured to:
receive an Ethernet frame including a media access control (MAC) address on one of the full-duplex bus links;
propagate the Ethernet frame to a next node in the daisy-chain in the direction of the Ethernet frame; and
filter Ethernet frames for the node based on the MAC address.

19. The node of claim 9, wherein the one or more other nodes in the tunnel include a subset of the plurality of nodes connected in the daisy-chain.

20. The node of claim 9, comprising a programmable register defining one or more of:
participation in Ethernet traffic;
downstream Ethernet tunnel enablement;
whether the node is a hub node;
whether the hub node transmits the token when the hub node has other Ethernet frames to transmit;
whether the node is an upstream end-node of the tunnel, a downstream end-node of the tunnel, or a mid-node of the tunnel;
upstream Ethernet tunnel enablement;
whether the next node is a high priority node;
a counter decrement level;
a point-to-point indication; or
an identifier of the next node.

21. The node of claim 9, wherein to transmit the Ethernet frame within the tunnel on the full-duplex bus links at least one of an upstream direction to a main-node or a downstream direction to a sub-node, the transceiver is configured to:
determine, based on a programmable register, a media access control (MAC) address of the node within the daisy-chain; and
transmit a plurality of superframes over one or both of an upstream full-duplex bus link or a downstream full-duplex bus link based on the MAC address of the node, wherein each superframe includes a portion of the Ethernet frame within a portion of a payload assigned to the tunnel.

22. A communication system comprising:
a plurality of nodes connected in a daisy-chain via respective bus links, wherein the plurality of nodes are configured for full-duplex, synchronized communication via a carrier-based modulation scheme over the bus links for transmission of superframes including a flexible payload, wherein to transmit Ethernet frames for an Ethernet tunnel among the plurality of nodes, a respective node of the Ethernet tunnel is configured to:
determine, based on a programmable register, a media access control (MAC) address of the respective node within the daisy-chain; and
transmit a plurality of superframes over one or both of an upstream full-duplex bus link or a downstream full-duplex bus link based on the MAC address of the node, wherein each superframe includes a portion of the Ethernet frame within a portion of the flexible payload assigned to the tunnel.

23. The communication system of claim 22, wherein the programmable register defines one or more of:
participation in Ethernet traffic;
downstream Ethernet tunnel enablement;
whether the node is a hub node;
whether the hub node transmits a token when the hub node has other Ethernet frames to transmit;
upstream Ethernet tunnel enablement;
whether a next node is a high priority node;
a counter decrement level;
a point-to-point indication; or
an identifier of the next node.

24. The communication system of claim 22, wherein the programmable register indicates a point-to-point tunnel between two of the nodes, and wherein each node of the point-to-point tunnel is configured to transmit Ethernet frames to the other node within the flexible payload of the superframes in a direction of the other node on the full-duplex bus links.

25. The communication system of claim 22, wherein the Ethernet tunnel includes three or more nodes, and wherein each node is configured to:
determine that the node has a transmit token;
transmit an Ethernet frame within a tunnel on the full-duplex bus links at least one of an upstream direction towards a main-node or a downstream direction towards an end-sub-node;
receive, while transmitting the Ethernet frame, a request for the transmit token from one or more other nodes in the tunnel on at least one of the full-duplex bus links in a direction opposite the Ethernet frame; and
transmit the transmit token to one of the other nodes based on a priority of the one or more other nodes.

26. The communication system of claim 22, wherein an Ethernet speed is programmable based on a size of the flexible payload and a data rate of the bus links.
